(19) United States
(12) Patent Application Publication
(10) Pub. No.: US 2014/0188458 A1
(43) Pub. Date: Jul. 3, 2014

(54) SYSTEM AND METHOD FOR DATA ENTRY BY ASSOCIATING STRUCTURED TEXTUAL CONTEXT TO IMAGES

(71) Applicant: NUESOFT TECHNOLOGIES INC., Marietta, GA (US)

(72) Inventors: Massoud Alibakhsh, Atlanta, GA (US); Shahram Famorzadeh, Marietta, GA (US)

(73) Assignee: NUESOFT TECHNOLOGIES INC., Marietta, GA (US)

(21) Appl. No.: 13/729,420

(22) Filed: Dec. 28, 2012

(51) Int. Cl. G06F 17/27

(52) U.S. Cl. CPC G06F 17/2785
USPC 704/9

(57) ABSTRACT

A system for data entry by associating structured textual context to images comprising a computer apparatus having a display device to facilitate interaction with a user. The system has electronics, data, tokens, grammatical rules, and an interface. The data is comprised of records, images, and template images, the template images having hotspots and sub-template images. The hotspots have a selection, and the sub-template images have sub-template hotspots, with the sub-template hotspots having a selection. The selections are preferably associated with diagnostic images, of which there are both general and template-specific.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The disclosure generally relates to data entry and processing, and more specifically to associating high level language with images, a user associating images with other images and functions, and creating context by enforcing grammatical rules.

This method can be applied in any industry where the production for detailed technical documents and databases is required. However, it will be of greatest benefit to the field of healthcare.

2. Description of Related Art

Medical practitioners must document all services performed for patients due to the Health Insurance Portability and Accountability Act, insurance, licensing, and other regulations. Current systems of documentation are very time consuming. Medical practitioners must know a plurality of textual diagnosis-specific and procedure-specific codes and input them into text fields on insurance forms, documentation forms, letters, and more. Entering patient encounter information (e.g., diagnoses, current procedural terminology codes, clinical notes, etc.) directly into these forms during examination is cumbersome.

There are many electronic records management systems that attempt to make data entry easier for medical practitioners. However, these systems have their shortcomings. The most common way of entering information in many of the above-mentioned systems is using combo boxes, list boxes, and text fields to populate forms with information. Forms represent templates for industry-specific documents. To notate severe redness in both eyes would require the user to make the following series of selections: Chief Complaint, Face, Eye, Left, Redness, Severe, Chief Complaint, Face, Eye, Right, Redness, Severe. This method is full of redundancy and is not practical for data entry during the patient examination.

One solution attempted has been the use of speech recognition software to automatically transcribe patient information as the medical provider speaks. However, this solution provides context-free data which cannot be indexed in a database. Thus, the context-free data needs to be transcribed by hand into structured language.

Another system guides medical providers through patient interviews based on information entered. However, this system is completely textual. Further, the information entered is not translated into structured language. The user is limited to the template reports offered within the system. The textual interface combined with the lack of database make this system impractical for the modern technological environment.

Another proposed solution embeds hotspots in exemplary images. These hotspots are associated with a pre-populated diagnosis template. After selecting the proper template, medical practitioners manually edit the pre-populated diagnosis template to match the patient. However, this solution reverts back to text entry during the latter half of the method. Further, the accuracy of the diagnosis could be compromised if the medical practitioner does not thoroughly remove the unnecessary pre-populated ICD-9 and CPT codes, wherein ICD codes are alphanumeric designations given to every diagnosis, description of symptoms and cause of death attributed to humans, and wherein CPT (Current Procedural Terminology) codes are numbers assigned to every task and service a medical practitioner may provide to a patient, such as medical, surgical and diagnostic services.

Another system uses a hand-held processor to enter data during the patient encounter. This device allows the doctor to enter surgical information into an image template. The device can later utilize the surgical data to populate a medical record or spreadsheet with ICD-9 and CPT codes. However, the system's ability to generate reports and translate the information entered is very limited.

Yet another proposed solution populates graphic representations of patient information to fixed and preset positions on a graphical template of the patient. Patient information cannot be placed on the template by the user. The resulting depiction is printed out and physically placed near the patient. Once a record is created it cannot be changed. The purpose of this depiction is to alert medical staff of a patient's allergies, state, and triage information.

Other proposed solutions allow the user to enter expressions into the interface and manipulate the overall structure of the combined expressions with graphic representation. These systems require the user to have intricate knowledge of the syntax and grammar associated with the target programming language. Further, the flowchart design of these systems makes their interfaces large and unmanageable.

Therefore, it is readily apparent that there is a need for a system that allows easy data input while associating the input data with predefined and recognized vocabulary.

### SUMMARY

Briefly described, in an exemplary embodiment, the present apparatus and method overcomes the above-mentioned disadvantages and meets the recognized need for such a device by providing an Electronic Medical Record/Electronic Health Record (EMR/EHR) system that associates high level language, such as industry-specific and domain-specific language, grammar, or vocabulary with images, creates context by enforcing industry-specific and/or domain-specific language, and creates customizable documents from data entered.

The present apparatus and method shortens the time required for data entry. During patient encounters, a medical practitioner can record patient data by using a graphical programming interface. The system allows the user to “paint” attributes and actions on to the affected area in a graphical representation of the subject matter being diagnosed. The system also allows users to select the affected area first and then select applicable attributes and actions. The ability to make selections in reverse makes the interface more culturally intuitive for some users.

The attributes, actions, and patient graphics are representations of structured language and industry-specific variables. For example, applying the attributes “severe” and “redness” to the image will simultaneously build the patient record in structured language. Reversing this process gives the software an intuitive feel to people of all cultures. For example, a Francophone medical practitioner would not say, “the blue chair.” Instead, he/she would say, “the chair blue.”

Attributes and actions are applied in such a way that industry-specific grammatical rules are enforced. The images represent high level language and the industry-specific grammatical rules can be combined to form new commands. For example, the practitioner can select “redness” and “swelling” then apply it to the eyes. However, the practitioner could not apply the above attributes to the hair because they would not be applicable to that area of the anatomy and would not match the industry-specific grammatical rules. Likewise, the system would not allow the practitioner to select “redness” and “pallor” because the program would understand that these attributes are opposites.

Once information is input into the system, the code generator compiles it into structured language for storage in a database. Because of the structured language, the user can produce reports in varying formats and/or natural languages comprised of textual data and/or images. Also, existing data can be recalled in order to be edited.

The primary goal of the disclosed embodiments is to make data entry, processing, and report generation quicker and more accurate for diagnostic professionals and support personnel. The secondary goal is to provide a means of automatically storing diagnostic information that is readily available in almost any natural language and standard or industry and domain-specific format.

According to its major aspects and broadly stated the system for data entry by associating structured textual context to images comprises a computer apparatus having a display device to facilitate interaction with a user. The computer apparatus comprises a machine-readable medium, where data is stored, the data comprising an association between a plurality of the images to create information. The computer also has a data entry processing module, the data entry processing module having a lexical analyzer, a code generator and a parser.

The computer apparatus also has a graphical user interface, the graphical user interface being displayed on the display device, and the graphical user interface having a notes section, a primary views section, and a secondary views section, and the data is input into the graphical user interface by a user. The computer apparatus also has a grammar module, the grammar module having multiple grammar files, the grammar files having rules that comprise industry-specific and domain-specific rules. It will be recognized by those skilled in the art that a single computer may comprise the machine-readable medium, the display device, the data entry processing module, and the graphical user interface, or the elements may be distributed across two or more computers that are preferably networked, or at least networkable.

The industry-specific rules have an industry-specific semantic rule, an industry-specific syntactic rule, and an industry-specific vocabulary rule. The domain-specific rules have a domain-specific semantic rule, a domain-specific syntactic rule, and a domain-specific vocabulary rule. Industry-specific refers to the general industry wherein the present apparatus and method is used: as described in an exemplary embodiment, the industry is health care, but could also be auto-repair, IT maintenance/repair, etc. Domain-specific refers to the sub-category within an industry where the present apparatus and method is used: as described in an exemplary embodiment, the domain is general practitioner, but could also be cardiologist, internist, and the like, but also more generally could include anyone performing a diagnostic or amending or editing an existing diagnostic.

The lexical analyzer tokenizes the information stored in the computer apparatus' machine readable medium into tokenized data. The parser in the data entry processing module compares the tokenized data to the rules. The code generator in the data entry processing module processes the stored tokenized data into resultant language.

A first image is selected from a plurality of images stored in the computer apparatus' machine readable medium, via a graphical user interface on the display device generated by the computer apparatus. Subsequently, a second image is associated at least to the first image to form an association, the images being selected from the group of template images, template hotspots, and characteristic images, characteristic images being attribute images and action images. Information is created from the association that will be stored on the computer apparatus' machine readable medium, the information being further defined by a grammar module stored on the computer apparatus' machine-readable medium, the grammar module having a plurality of grammar files, the grammar files having rules that include industry-specific grammar rules and domain-specific grammar rules, the industry-specific grammar rules having an industry-specific semantic rule, an industry-specific syntactic rule, and an industry-specific vocabulary rule, and the domain-specific grammar rules having a domain-specific semantic rule, a domain-specific syntactic rule, and a domain-specific vocabulary rule.

The industry-specific grammar rules and the domain-specific grammar rules define a first group of images, and also define the relationship of the first group of images to at least a second group of images.

The association is tokenized into tokenized data via the data entry processing module on the computer apparatus, which has a lexical analyzer, a code generator and a parser, and subsequently the tokenized data is compared to the rules.

A second association is entered via the graphical user interface on the computer apparatus' display device if the tokenized data from the data entry processing module is inconsistent with the rules. The tokenized data is processed into resultant language via the data processing module on the computer apparatus.

The graphical user interface on the display device on the computer apparatus shows previously entered tokenized data in at least one of a plurality of views.

A second association is entered via the graphical user interface on the computer apparatus' display device if the displayed previously entered tokenized data requires updating for reasons other than inconsistency with the rules.

Accordingly, a feature of the present disclosure is its ability to allow easy data input while associating the input data automatically with predefined and recognized vocabulary.

Another feature of the present disclosure is its ability to allow diagnostic professionals to quickly enter diagnoses into a computer system.

Still another feature of the present disclosure is its ability to provide a system that confirms a diagnosis is logically consistent.

Yet another feature of the present disclosure is its ability to provide an efficient method of producing reports from diagnostic records, and for example, patient records.

Yet still another feature of the present disclosure is its ability to reduce the redundancy necessary for diagnostic professionals, specifically medical professionals having to create records that evidence patient visits.

A further feature of the present disclosure is its ability to provide a system that does not require a prohibitively high learning curve for users.

These and other features of the present disclosure will become more apparent to one skilled in the art from the Summary, Brief Description of the Drawings, Detailed Description, and Claims when read in light of the accompanying Detailed Drawings.

### BRIEF DESCRIPTION OF THE DRAWINGS

The present disclosure will be better understood by reading the Detailed Description of the Embodiment with reference to the accompanying drawings, which are not necessarily drawn to scale, and in which like reference numerals denote similar structure and refer to like elements throughout, and in which:

FIG. 1 is a schematic view of a system for data entry by associating structured textual context to images, according to an exemplary embodiment;

FIG. 2 is a flowchart depicting a typical interaction session with the system, according to an exemplary embodiment;

FIG. 3 is a screen shot view of an exemplary interface screen depicting medical diagnostic template images, correlated with elements of data, according to an exemplary embodiment;

FIG. 4 is a screen shot view of an exemplary interface screen depicting images, according to the embodiment of FIG. 3;

FIG. 5 is a screen shot view of an exemplary interface screen depicting automobile diagnostic template images, correlated with elements of data, according to an alternate embodiment;

FIG. 6 is a screen shot view of an exemplary interface screen depicting images, according to the embodiment of FIG. 5;

FIG. 7 is a screen shot view of an exemplary interface screen depicting technology diagnostic template images, correlated with elements of data, according to an alternate embodiment;

FIG. 8 is a screen shot view of an exemplary interface screen depicting images, according to the embodiment of FIG. 7;

FIG. 9A is a schematic view depicting the elements of data, according to the embodiments of FIG. 1 and FIG. 2;

FIG. 9B is a schematic view depicting the elements of template images, according to the embodiments of FIG. 1 and FIG. 2;

FIG. 9C is a schematic view depicting the elements of diagnostic images, according to the embodiments of FIG. 1 and FIG. 2;

FIG. 9D is a schematic view depicting the elements of industry-specific grammatical rules and tokens, and their relationship, according to the embodiments of FIG. 1 and FIG. 2; and

FIG. 9E is a flowchart depicting the sub-steps involved when a user associates images, according to the embodiments of FIG. 1 and FIG. 2.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

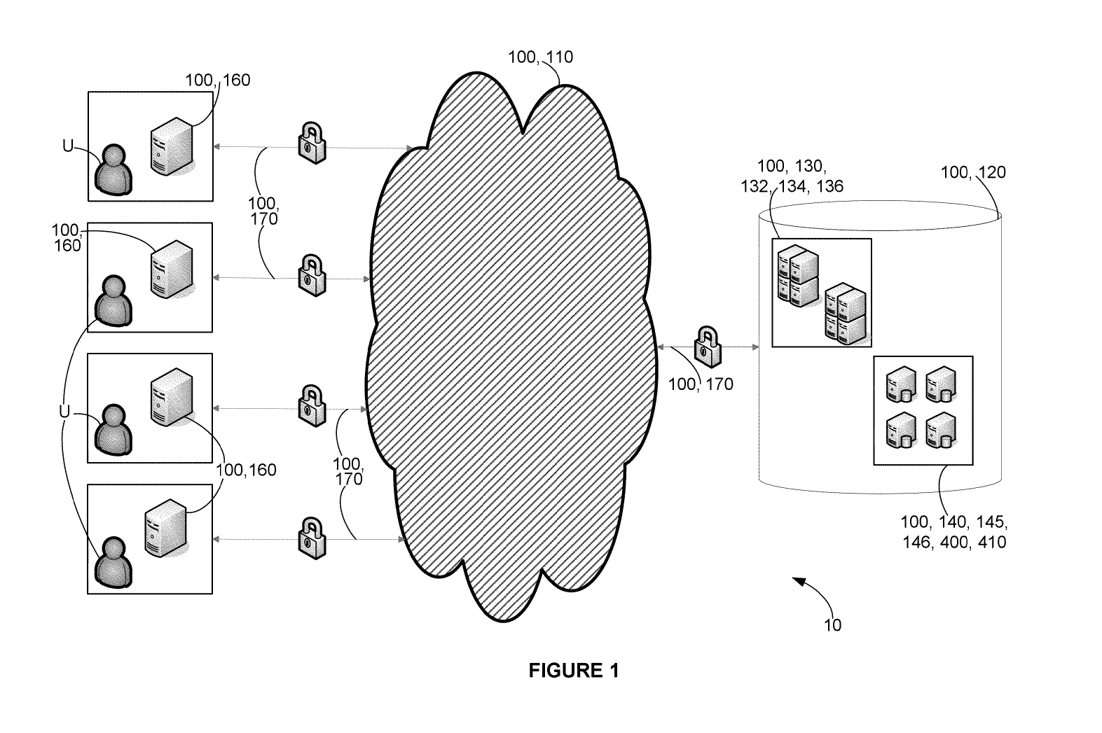

In describing the exemplary embodiment of the present disclosure, as illustrated in FIGS. 1-9E, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIGS. 1-9E, by way of example, and not limitation, there is illustrated an example embodiment of system 10 for data entry by associating structured textual context to images, wherein system 10 comprises computer apparatus 100, data 200, tokenized data 300, and grammar module 400. Computer apparatus 100 comprises machine-readable medium 105, network 110, servers 120, display device 160, and secure communication links 170, wherein servers 120 comprise data processing module 130 and database servers 140 (best shown in FIG. 1). Data entry processing module 130 comprise lexical analyzer 132, parser 134, and code generator 136, and database servers 140 comprise database 145, wherein database 145 comprises reports 146.

It will be recognized by those skilled in the art that network 110 may be a LAN, WAN, VPN, or any network configuration of electronic devices. It will further be recognized that application servers 130 and database servers 140 may function on separate computers (best shown in FIG. 1), or alternatively may function on the same computer (not shown). It will further be recognized that in an alternate embodiment (not shown), computer apparatus 100 may comprise a single computer that comprises both server 120 and display device 160.

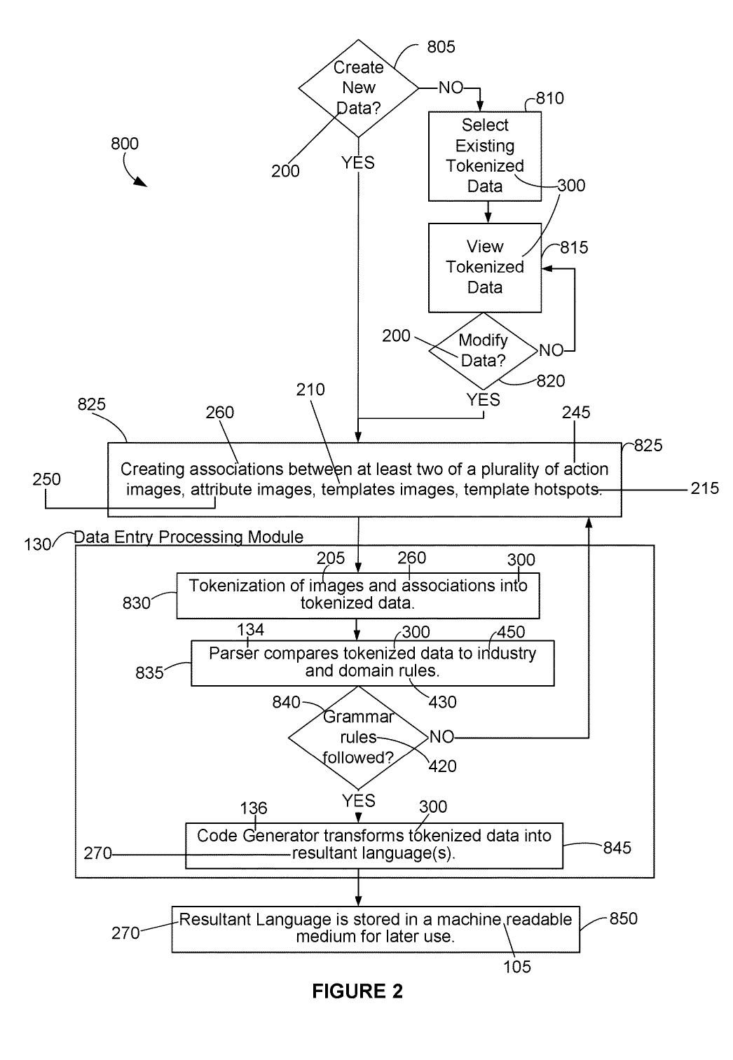

Turning now to FIG. 2, in use, diagnostic professional or other user U begins session 800 at step 805, wherein user U optionally decides whether to create new data 200. If user U decides not to create new data 200, then user U selects tokenized data 300 via step 810, and tokenized data 300 is displayed via step 815. Subsequently, at step 820, if user U decides to modify to data 200, then session 800 proceeds to step 825; whereas if user U decides not to modify data 200, then session 800 proceeds back t step 815.

Via step 825, user U creates associations 260 between at least two of a plurality of actions images 245, attribute images 250, template images 210, and/or template hotspots 215.

Subsequently at step 830, which takes places within data entry processing module 130, tokenization of images 205 and associations 260 into tokenized data 300. At step 835, parser 134 compares tokenized data 300 to industry-specific grammar rules 450 and domain-specific grammar rules 430. Via step 840, if grammar rules 420 are followed, then session 800 proceeds to step 845; if not, session 800 proceeds back to step 825. At step 845, code generator 136 transforms tokenized data 300 into resultant language(s) 270.

At step 850, resultant language 270 is stored in machine readable medium 105 for later use.

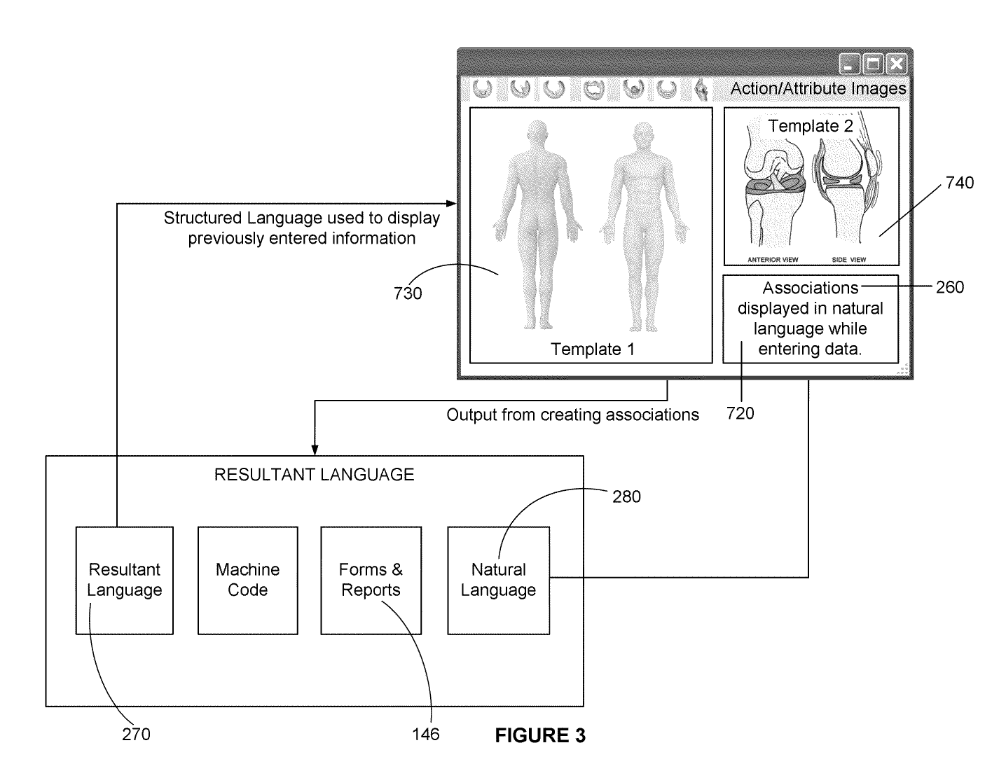

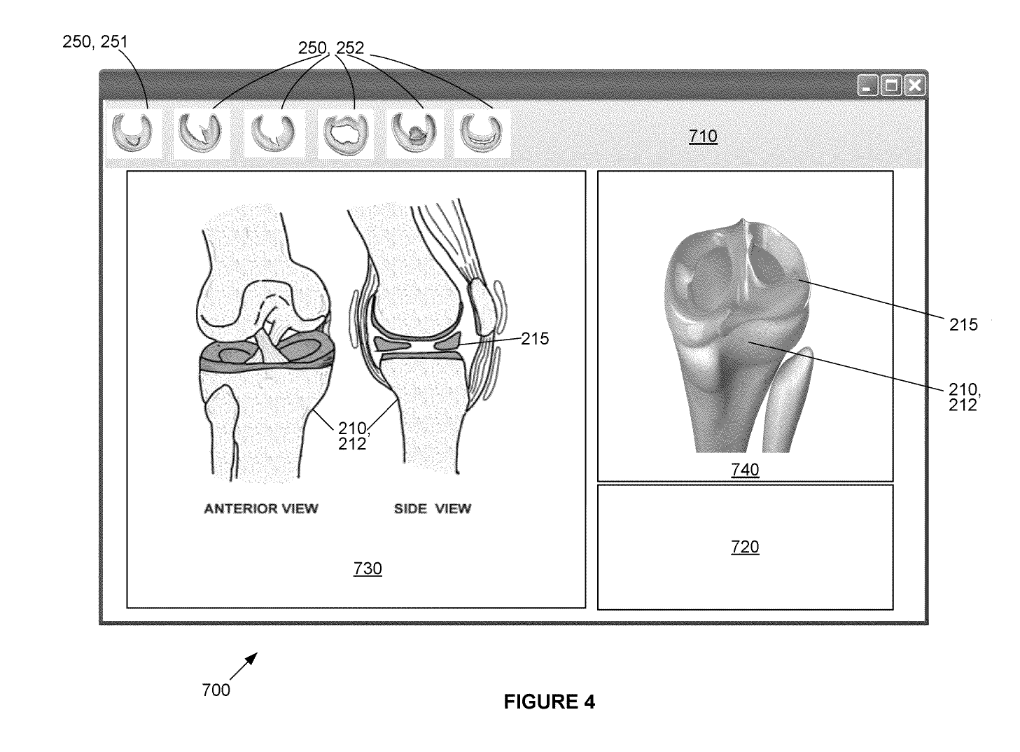

Turning now to FIGS. 3 and 4, the relationship between medical diagnostic graphical user interface 700 and data 200 is shown. Natural language 280 is displayed in notes section 720, associations 260 are translated to resultant language 270, and resultant language 270 previously created is displayed on interface 700, in status bar 710, notes section 720, primary views section 730, and secondary views section 740.

Turning now more particularly to FIG. 4, interface 700 comprises status bar 710, notes section 720, primary views section 730, and secondary views section 740. Displayed within status bar 710 in this particular screen-shot are general attribute images 251 and template-specific attribute images 252, which are both attribute images 250. Displayed within primary views section 730 in this particular screen-shot are template images 210, template perspective views 212, and template hotspots 215. Displayed within secondary views section 740 in this particular screen-shot are template images 210, template perspective views 212, and template hotspots 215. Displayed within notes section 720 is natural language 280.

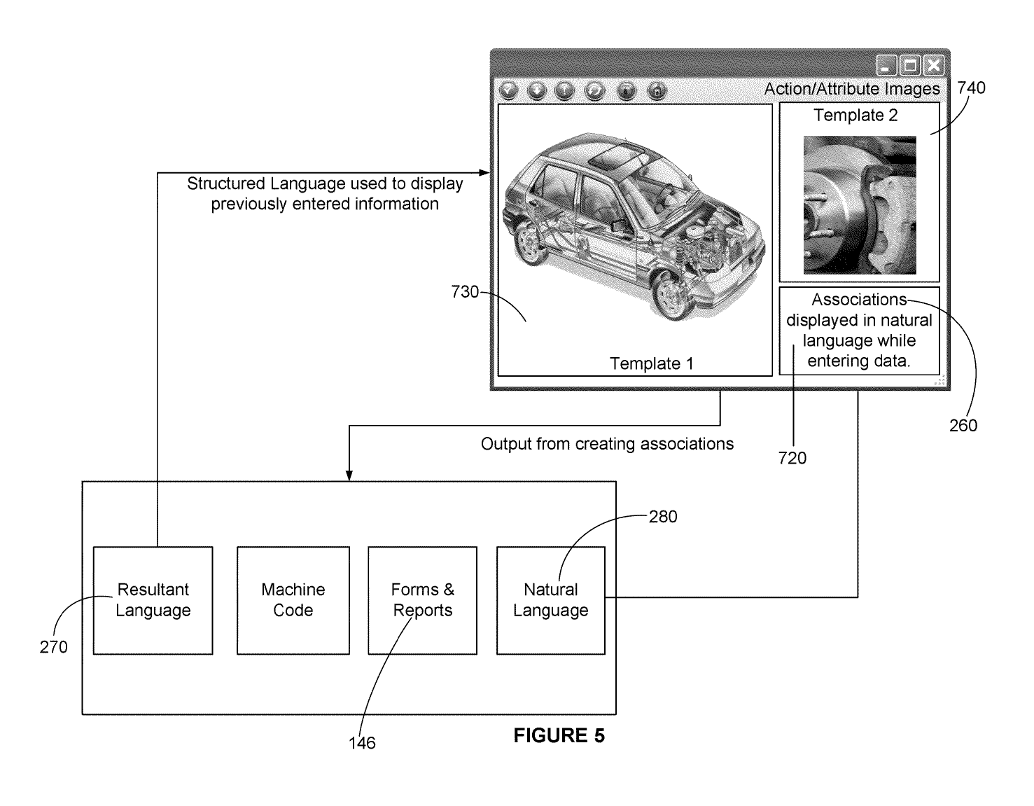

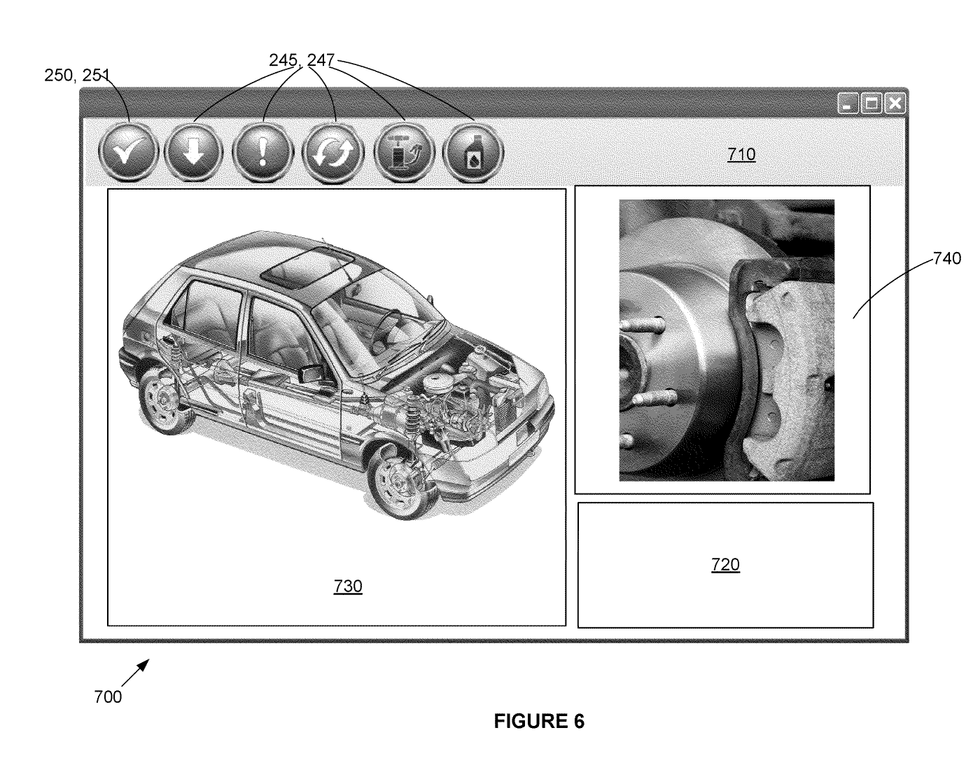

Turning now to FIGS. 5 and 6, in an alternate embodiment, system 100 can be used by auto mechanics, with elements preferably similarly displayed and organized as in other embodiments, wherein in FIGS. 5 and 6, in status bar 710 elements of characteristic images 240 are displayed as in FIGS. 3 and 4. More specifically FIGS. 5 and 6, disclose the relationship between automobile diagnostic graphical user interface 700 and data 200 is shown. Natural language 280 is displayed in notes section 720, associations 260 are translated to resultant language 270, and resultant language 270 previously created is displayed on interface 700, in status bar 710, notes section 720, primary views section 730, and secondary views section 740.

Turning now more particularly to FIG. 6, interface 700 comprises status bar 710, notes section 720, primary views section 730, and secondary views section 740. Displayed within status bar 710 in this particular screen-shot are general attribute images 251 and template-specific attribute images 252, which are both attribute images 250. Displayed within primary views section 730 in this particular screen-shot are template images 210, template perspective views 212, and template hotspots 215. Displayed within secondary views section 740 in this particular screen-shot are template images 210, template perspective views 212, and template hotspots 215. Displayed within notes section 720 is natural language 280.

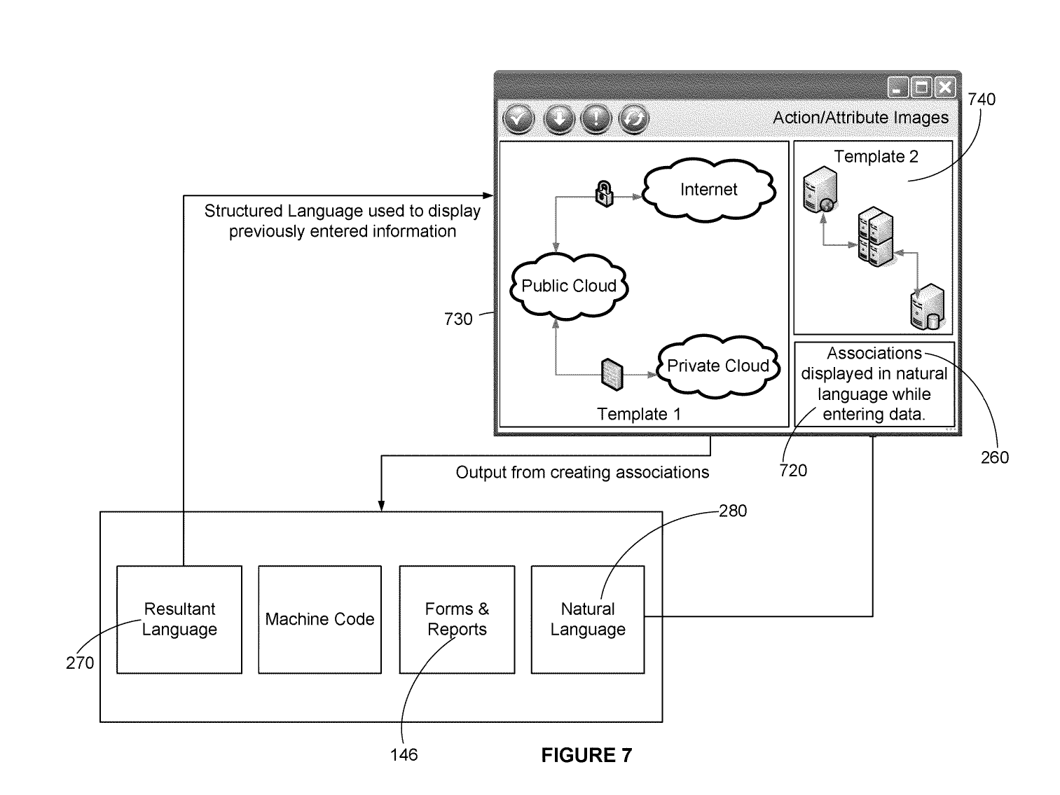

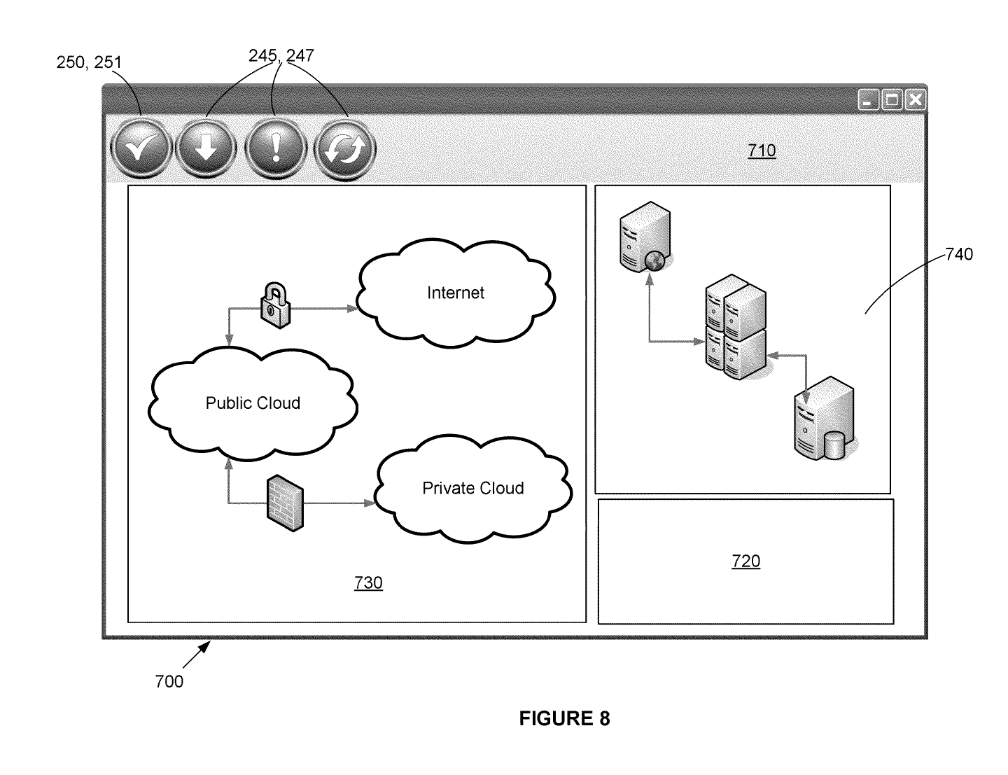

Turning now to FIGS. 7 and 8, in an alternate embodiment, system 100 can be used on auto mechanics, with elements preferably similarly displayed and organized as in other embodiments, wherein in FIGS. 7 and 8, in status bar 710 elements of characteristic images 240 are displayed as in FIGS. 3 and 4. More specifically FIGS. 7 and 8, disclose the relationship between technology diagnostic graphical user interface 700 and data 200 is shown. Natural language 280 is displayed in notes section 720, associations 260 are translated to resultant language 270, and resultant language 270 previously created is displayed on interface 700, in status bar 710, notes section 720, primary views section 730, and secondary views section 740.

Turning now more particularly to FIG. 8, interface 700 comprises status bar 710, notes section 720, primary views section 730, and secondary views section 740. Displayed within status bar 710 in this particular screen-shot are general attribute images 251 and template-specific attribute images 252, which are both attribute images 250. Displayed within primary views section 730 in this particular screen-shot are template images 210, template perspective views 212, and template hotspots 215. Displayed within secondary views section 740 in this particular screen-shot are template images 210, template perspective views 212, and template hotspots 215. Displayed within notes section 720 is natural language 280.

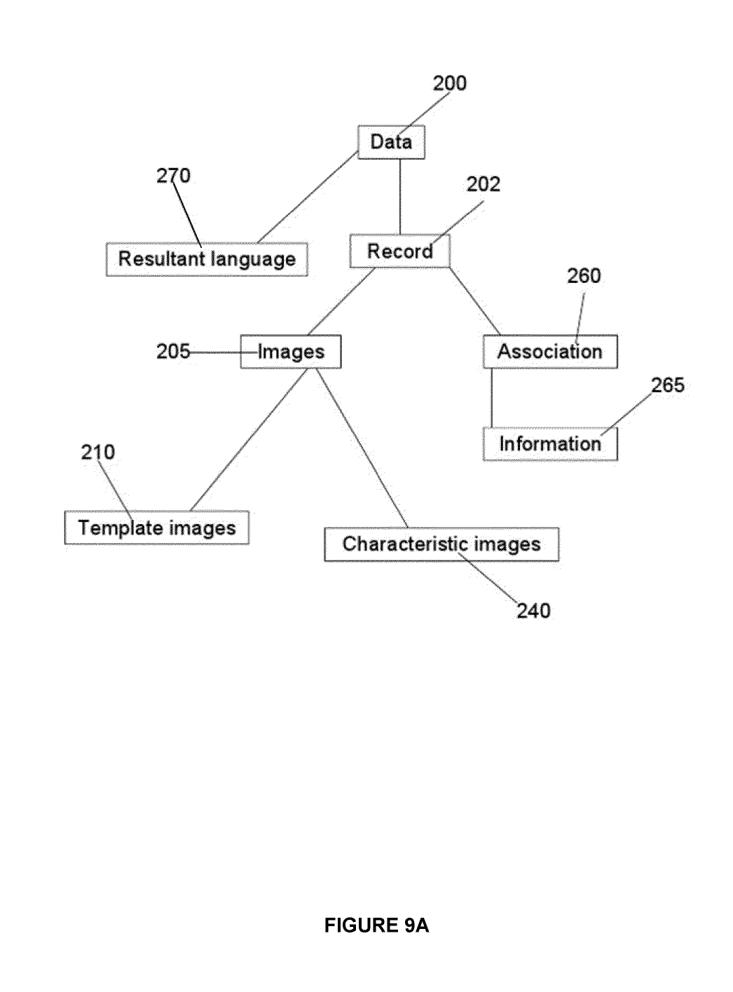

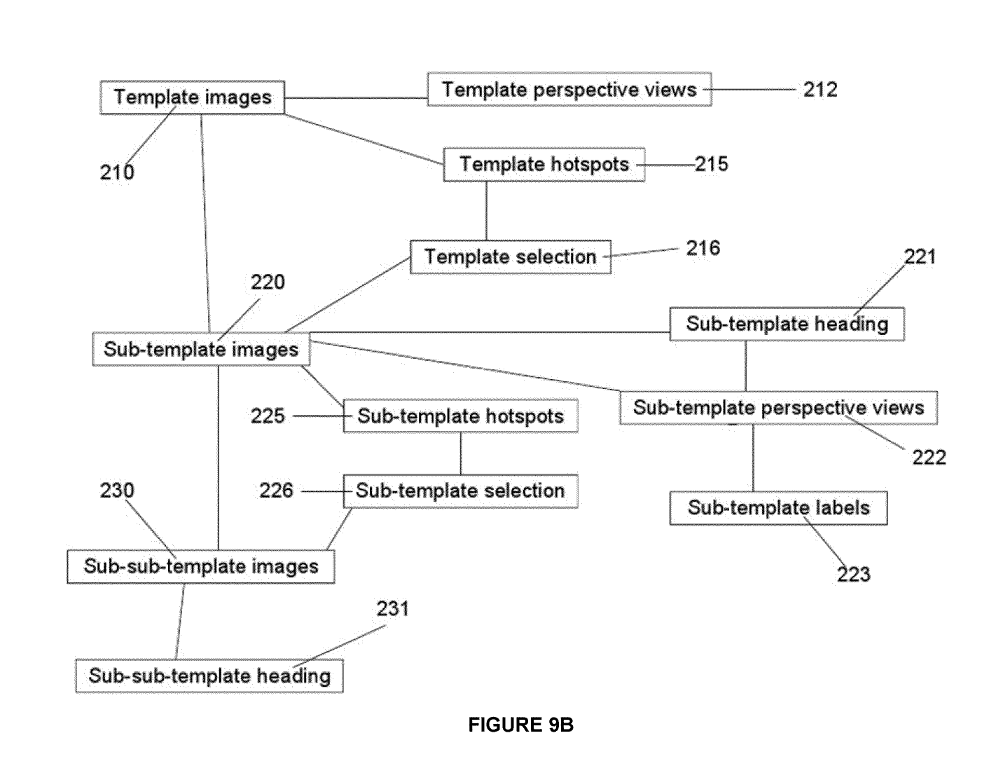

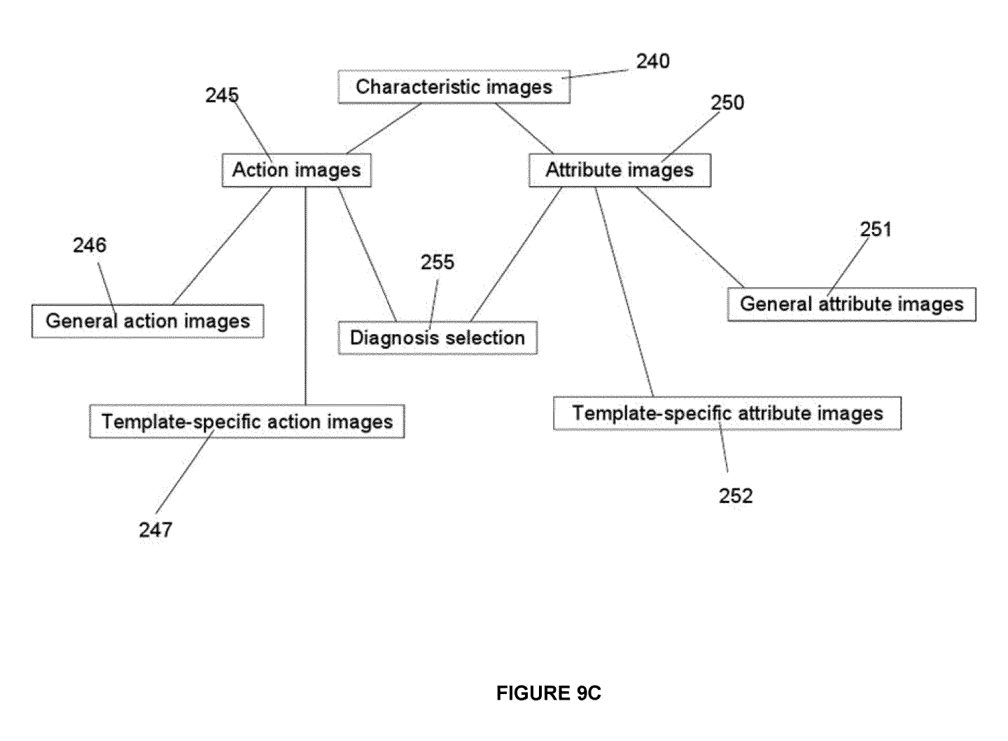

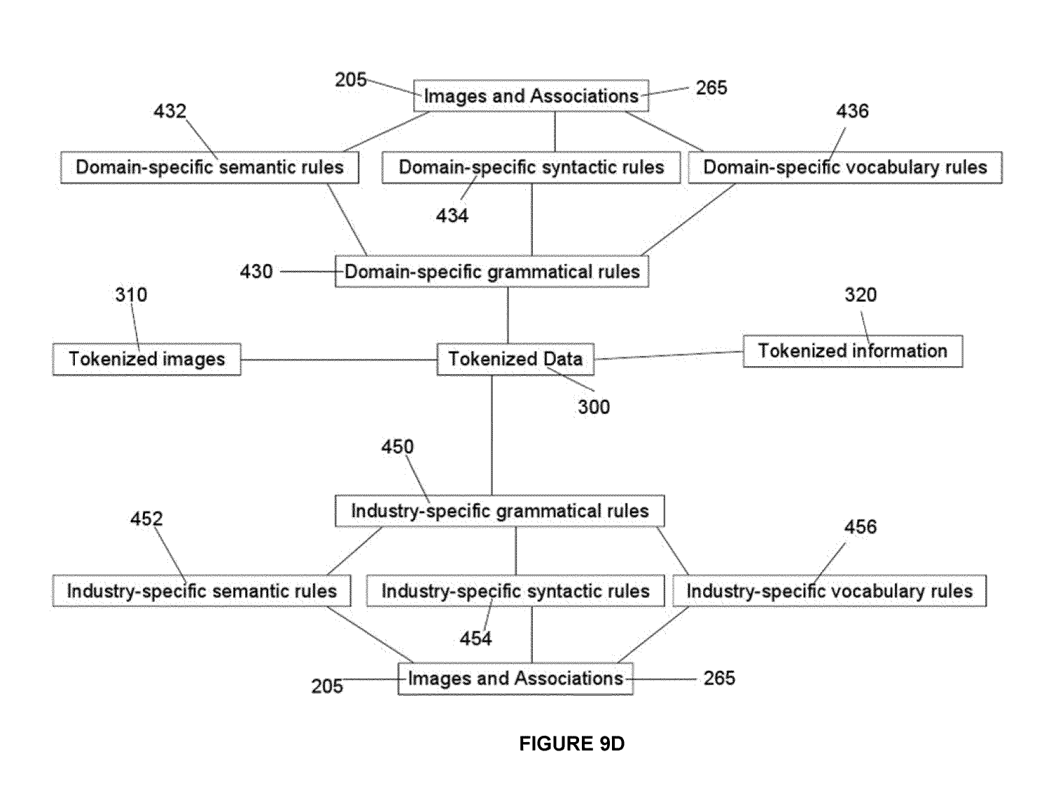

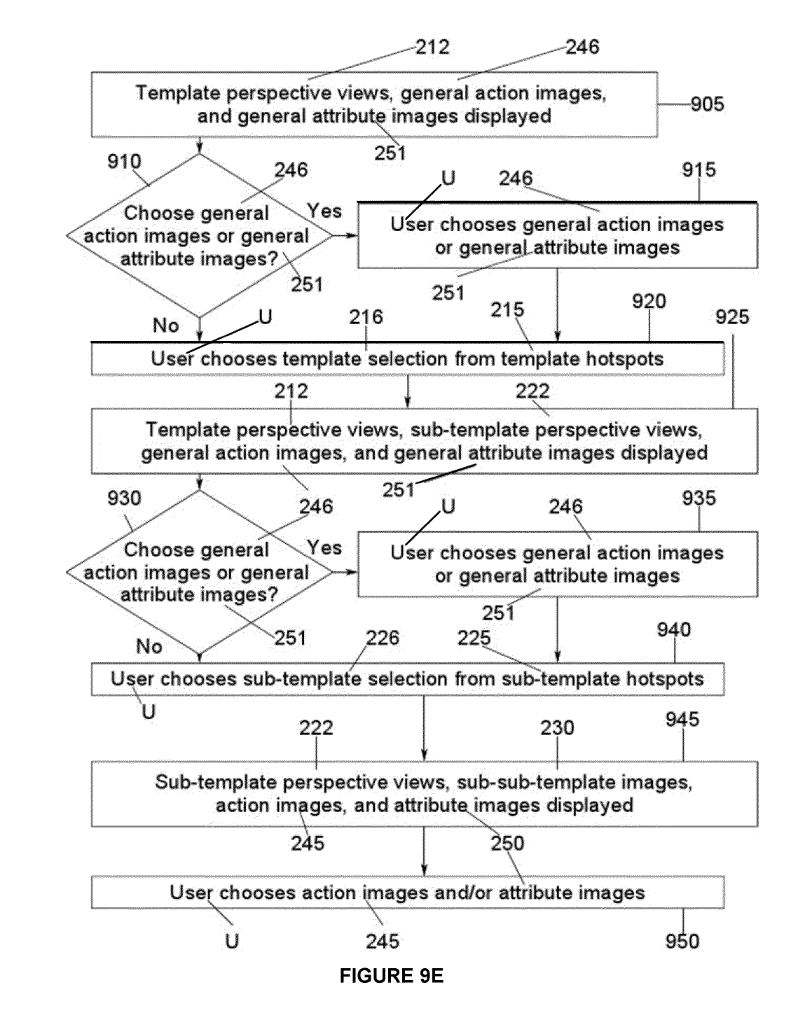

In an exemplary use, when session 800 is in step 825, step 825 preferably comprises the steps in FIG. 9E. Template perspective views 212, general action images 246, and general attribute images 251 are displayed via step 905. Via step 910, if user U wishes to choose general action image 246 or general attribute image 251, then user U proceeds to step 915; otherwise, user U proceeds to step 920. User U selects a general action image 246 and/or a general attribute images 251 via step 915, and subsequently proceeds to step 920. Via step 920, user U chooses template selection 216 from template hotspots 215 (best shown in FIG. 4). Subsequently, via step 925, template perspective views 212, sub-template perspective views 222, general action images 246, and general attribute images 251 are displayed. Via step 930, if user U wishes to choose a general action image 246 and/or a general attribute image 251, then user U proceeds to step 935; otherwise, user U proceeds to step 940. User U selects a general action image 246 and/or a general attribute image 251 via step 935, and subsequently proceeds to step 940. Via step 940, user U chooses sub-template selection 226 from sub-template hotspots 225 (best shown in FIG. 4). Subsequently, sub-template perspective views 222, sub-sub-template images 230, attribute images 250, and action images 245 are displayed via step 945. Via step 950, user U selects attribute images 250 and action images 245. Concurrently, natural language 280 is displayed in notes section 720, wherein natural language 280 describes associations 260 between images 205. For exemplary purposes only, if system 100 is being used in the medical diagnostic field (best shown in FIGS. 3-4), natural language 280 in notes section 720 could comprise “Patient has a partial tear in the medial collateral ligament in the left knee.” Again for exemplary purposes only, if system 100 is being used in the auto-repairs field (best shown in FIGS. 5-6), natural language 280 in notes section 720 could comprise “Vehicle has misaligned front tires and the rear tires' tread is worn down and needs replacement.” Again for exemplary purposes only, if system 100 is being used in the information technology field (best shown in FIGS. 7-8), natural language 280 in notes section 720 could comprise “Latency between remote network and main network is interfering with functionality of some applications.”

Turning now to FIG. 9A, data 200 comprises record 202 and resultant language 270, wherein record 202 comprises images 205 and association 260. Images 205 comprise characteristic images 240 and template images 210, and association 260 comprises information 265.

Turning to FIG. 9B, template images 210 comprise template perspective views 212, sub-template images 220 and template hotspots 215, wherein template hotspots 215 comprise template selection 216, and wherein template selection 216 is related to sub-template images 220. Sub-template images 220 comprise sub-template perspective views 222, sub-template heading 221, sub-sub-template images 230, and sub-template hotspots 225, wherein sub-template perspective views 222 comprises sub-template labels 223, and wherein sub-template hotspots 225 comprise sub-template selection 226, and wherein sub-template selection 226 relates to sub-sub-template images 230, and wherein sub-sub-template images 230 comprise sub-sub-template heading 231.

In an exemplary embodiment, there is a plurality of template hotspots 215, wherein user U selects one of template hotspots 215 as template selection 216. Each template selection 216 is preferably associated with a specific sub-template image 220. Similarly, there is a plurality of sub-template hotspots 225, wherein user U optionally selects one of sub-template hotspots 225 as sub-template selection 226, and wherein each sub-template selection 226 is associated with a specific sub-sub-template image 230.

Turning now to FIG. 9C, characteristic images 240 comprise action images 245 and attribute images 250, wherein action images 245 comprise general action images 246 and template-specific action images 247, and wherein attribute images 250 comprise general attribute images 251 and template-specific attribute images 252. Action images 245 and attribute images 250 further collectively comprise diagnosis selection 255.

Turning now to FIG. 9D, tokenized data 300 comprises tokenized images 310 and tokenized information 320, wherein tokenized data 300 are preferably defined as a string of characters categorized according to industry-specific grammatical rules 450 and domain-specific grammatical rules 430. Industry-specific grammatical rules 450 comprise industry-specific semantic rules 452, industry-specific syntactic rules 454, and industry-specific vocabulary rules 456, and collectively define which images 205 are validly in associations 260. Domain-specific grammatical rules 430 comprise domain-specific semantic rules 432, domain-specific syntactic rules 434, and domain-specific vocabulary rules 436, and collectively define which images 205 are validly in associations 260.

In a preferred embodiment, industry-specific semantic rules 452 recognize that medical professions do not always refer to maladies by their correct scientific name. For example, a patient may be diagnosed with “strep throat” even though “strep throat” is an informal way of describing an infection by the Group A Streptococcus bacteria. In a preferred embodiment, industry-specific vocabulary rules 456 is associated with images 205 and information 265, wherein said association 260 defines which tokenized data 300 are created from data 200 by lexical analyzer 132. Further, industry-specific grammatical rules 450 are preferably interchangeably stored in database 145.

In a preferred embodiment, reports 146 comprise any report that must be generated either by the doctor or any member of the medical team, including, without limitation, an insurance claim, a paper-copy of the diagnosis, and/or a receipt for the patient's records. Further, reports 146 are preferably created in industry-specific formats or standard formats, wherein said formats include, without limitation and for exemplary purposes only, Microsoft Excel Spreadsheet, Microsoft Word Document, Open Document Text, Open Document Spreadsheet, Hypertext Markup Language, Structured Query Language, Postscript, PCL, Portable Network Graphics, Tagged Image File Format, Portable Document Format, Assembler Language Source, Extensible Markup Language, ICalendar, Comma Separated Values, and Health Level Seven.

Turning back to FIG. 9C, in a preferred embodiment, action images 245, which are preferably displayed in status bar 710 in FIGS. 3-8, preferably comprise various actions that have previously been performed or should be performed, including, without limitation, taking prescription medication and/or receiving an injection via hypodermic needle, wherein general action image 246 includes, for exemplary purposes only and without limitation, taking prescription medication, and wherein template-specific action image 247 includes, for exemplary purposes only and without limitation, receiving an injection via hypodermic needle. Further, in a preferred embodiment, attribute images 250, which are also preferably displayed in status bar 710 in FIGS. 3-8, comprise various maladies that have previously been present or are being diagnosed as currently present, including, without limitation, a torn horn and/or swelling, wherein general attribute image 251 includes, for exemplary purposes only and without limitation, swelling, and wherein template-specific attribute image 252 includes, without limitation and for exemplary purposes only, a torn horn.

In an exemplary embodiment, system 10 functions in a cloud computing environment, wherein the cloud computing environment comprises a scalable distributed service that provides computing and storage resources. Servers 120 communicate graphical user interface 700 to display device 160 via secure communication links 170 (best shown in FIG. 1). Further, display device 160 and servers 120 are preferably computers with processors, but may optionally be other functionally equivalent or similar electronic devices, such as, for exemplary purposes only and without limitation, cell phones, tablets, or “thin client” devices.

In an exemplary embodiment, both reports 146 and graphical user interface 700 are displayed in any natural language, wherein system 10 comprises the ability to translate between data 200 and all natural languages.

The term “natural language” includes all languages generally used, such as, for exemplary purposes and without limitation, English, French, Farsi, Spanish, and the like.

The foregoing description and drawings comprise an illustrative embodiments of the present disclosure. Having thus described exemplary embodiments of the present disclosure, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

1. A system for data entry by associating structured textual context to images comprising a computer apparatus having a display device to facilitate interaction with a user, the computer apparatus comprising:
machine-readable medium, wherein data is stored, wherein the data comprises an association between a plurality of the images to create information;
a data entry processing module, wherein the data entry processing module comprises a lexical analyzer, a code generator and a parser;
a graphical user interface, wherein the graphical user interface is displayed on the display device, and wherein the graphical user interface comprises a notes section, a primary views section, and, optionally, a secondary views section, and wherein data is input into the graphical user interface by a user; and
a lexical grammar module, wherein the lexical grammar module comprises a plurality of lexical grammar files, wherein the lexical grammar files comprise rules that further comprise industry-specific and domain-specific rules.

2. The system of claim 1, wherein the industry-specific rules comprise:
an industry-specific semantic rule;
an industry-specific syntactic rule; and
an industry-specific vocabulary rule.

3. The system of claim 2, wherein the domain-specific rules comprise:
a domain-specific semantic rule;
a domain-specific syntactic rule; and
a domain-specific vocabulary rule.

4. The system of claim 3, wherein:
the lexical analyzer in the data entry processing module tokenizes the information stored in the computer apparatus' machine readable medium into tokenized data;
the parser in the data entry processing module compares the tokenized data to the rules; and
the code generator in the data entry processing module processes the stored tokenized data into resultant language.

5. A method for data entry by associating structured textual context to images comprising a computer apparatus having a display device to facilitate interaction with a user, the method comprising the steps of:
selecting a first image from a plurality of images stored in the computer apparatus' machine readable medium, via a graphical user interface on the display device generated by the computer apparatus, then:
associating at least a second image to the first image to form an association, wherein the images are selected from a group consisting of:
template images;
template hotspots;
characteristic images, wherein the characteristic images comprise attribute images and action images; and
combinations thereof; and
creating information from the association that will be stored on the computer apparatus' machine readable medium, wherein the information is further defined by:
a lexical grammar module stored on the computer apparatus' machine-readable medium, wherein the lexical grammar module comprises a plurality of lexical grammar files, wherein the lexical grammar files comprise rules that further comprise industry-specific lexical grammar rules and domain-specific lexical grammar rules, wherein the industry-specific lexical grammar rules comprise an industry-specific semantic rule, an industry-specific syntactic rule, and an industry-specific vocabulary rule, and wherein the domain-specific lexical grammar rules comprise a domain-specific semantic rule, a domain-specific syntactic rule, and a domain-specific vocabulary rule.

6. The method of claim 5, wherein the industry-specific lexical grammar rules and the domain-specific lexical grammar rules define: a first group of images, and further define the relationship of the first group of images to at least a second group of images.

7. The method of claim 6, further comprising the steps of:
tokenizing the association into tokenized data via a data entry processing module on the computer apparatus, comprised of a lexical analyzer, a code generator and a parser; and
comparing the tokenized data to the rules.

8. The method of claim 7, further comprising the step of:
entering at least a second association via the graphical user interface on the computer apparatus' display device if the tokenized data from the data entry processing module is inconsistent with the rules.

9. The method of claim 8, further comprising the step of:
processing the tokenized data into resultant language via the data processing module on the computer apparatus.

10. The method of claim 9, wherein the graphical user interface on the display device on the computer apparatus shows previously entered tokenized data in at least one of a plurality of views.

11. The method of claim 10, further comprising the step of:
entering at least a second association via the graphical user interface on the computer apparatus' display device if the displayed previously entered tokenized data requires updating for reasons other than inconsistency with the rules.
